(19) United States
(12) Patent Application Publication
(10) Pub. No.: US 2026/0061518 A1
(43) Pub. Date: Mar. 5, 2026

(54) LASER PROCESSING METHOD

(71) Applicant: HONDA MOTOR CO., LTD., Tokyo (JP)

(72) Inventors: Masayuki Inada, Wako-shi (JP); Tetsuya Ozawa, Wako-shi (JP); Seiji Sakuma, Wako-shi (JP)

(21) Appl. No.: 19/317,414

(22) Filed: Sep. 3, 2025

(30) Foreign Application Priority Data
Sep. 4, 2024 (JP) 2024-152405

(51) Int. Cl. B23K 26/26

(52) U.S. Cl. CPC B23K 26/26

(57) ABSTRACT

Provided is a laser processing method capable of ensuring both high welding strength and low current density while suppressing the area of a weld region at the time of welding a current collector foil and a tab lead of a battery. The laser processing method includes a step of laser welding a current collector foil 2 and a tab lead 3 at an end of a battery, wherein the laser welding is performed by radiating laser light selected from a blue laser and a green laser. When a direction in which the tab lead extends from the end of the battery is defined as a first direction, the laser welding is performed such that welds are arranged in a plurality of linear rows perpendicular to the first direction.

### CROSS-REFERENCE TO RELATED APPLICATION

Priority is claimed on Japanese Patent Application No. 2024-152405, filed Sep. 4, 2024, the content of which is incorporated herein by reference.

### BACKGROUND OF THE INVENTION

### Field of the Invention

The present invention relates to a laser processing method.

### Description of Related Art

Recently, research and development has been conducted on secondary batteries that contribute to energy efficiency such that more people can have access to affordable, reliable, sustainable, and advanced energy.

In laminated lithium-ion secondary batteries, the current collector foil and tab lead are generally joined by ultrasonic welding. However, ultrasonic welding has problems such as a large amount of metal powder scattering, changes in conditions due to changes in the horn and anvil over time, large changes in vibration application conditions due to the surface properties of the foil, and a need to ensure a large joining area due to attenuation of the thickness of the load application part.

In addition to ultrasonic welding, resistance welding and laser welding are also used for joining.

However, resistance welding has a problem in that the level of spatter scattering is greatly dependent on the maintenance status of the tool, such as adhesion of an oxide film.

As for laser welding, IR (wavelength around 1000 nm) laser welding is known. In IR laser welding, in order to maintain the joint strength, the joint area is generally increased by using wobbling using a beam with a narrow spot diameter (such as a fiber laser) in addition to continuous welding (CW) using a beam with a wide spot diameter, and intermittent radiation called percussion or trepanning.

In addition, Japanese Unexamined Patent Application, First Publication No. 2023-112734 discloses a laser processing method for processing a workpiece (piece to be processed) by emitting a laser beam, the workpiece having at least a first processing target portion and a second processing target portion located away from the first processing target portion, the laser beam including a first laser beam (e.g., a blue laser beam of 600 nm or less) and a second laser beam (e.g., an infrared laser beam of 800 nm or more) having a longer wavelength than the first laser beam, the laser processing method including a first process of emitting the first laser beam to the first processing target portion, a second process of emitting the second laser beam to the first processing target portion to which the first laser beam has been emitted, a third process of emitting the first laser beam to the second processing target portion, and a fourth process of emitting the second laser beam to the second processing target portion to which the first laser beam has been emitted.

Furthermore, Japanese Unexamined Patent Application, First Publication No. 2016-150363 discloses a laser welding method for welding a plurality of metal plates by irradiating the plurality of metal plates, which are objects to be welded, with a laser beam scanned by a scanning means for scanning a laser beam guided from a laser oscillator while moving the scanning means, the laser welding method performing a process of performing tack welding on predetermined points of the objects to be welded in a welding direction and a process of performing main welding on points corresponding to the temporarily fastened points of the objects to be welded within the scanning range of the scanning means while moving the scanning means. This document discloses that the shape of a weld is a spot shape with a diameter of about 2 mm.

### SUMMARY OF THE INVENTION

However, IR laser welding has a problem in that spatter scattering occurs significantly due to the low absorption rate of laser light caused by metals, especially when a target is a metal such as copper. Furthermore, no method is known that could ensure both high welding strength and low current density (low electrical resistance) while suppressing the area of a weld region when laser welding a battery current collector foil and a tab lead. Patent Documents 1 and 2 do not disclose welding between a battery current collector foil and a tab lead, nor the electrical characteristics of a weld.

Aspects of the present invention have been made in view of the above, and an object thereof is to provide a laser processing method capable of ensuring both high welding strength and low current density while suppressing the area of a weld region when welding a battery current collector foil and a tab lead. This will ultimately contribute to energy efficiency.

To achieve the above object, the present invention proposes the following means.
[1] A laser processing method including a step of laser welding a current collector foil and a tab lead at an end of a battery, wherein the step of laser welding is performed by radiating laser light selected from a blue laser and a green laser.

According to [1], at the time of laser welding the current collector foil and the tab lead of the battery, it is possible to ensure both high welding strength and low current density (low electrical resistance) while suppressing the area of a weld region.
[2] The laser processing method according to [1], wherein, when a direction in which the tab lead extends from the end of the battery is defined as a first direction, the laser welding is performed such that welds are arranged in a plurality of linear rows perpendicular to the first direction.

According to [2], the welding strength can be further enhanced and the current density can be further reduced.
[3] The laser processing method according to [2], wherein the number of rows of the welds is two to five or three.

According to [3], the welding strength can be further enhanced and the current density can be further reduced.
[4] The laser processing method according to [1], wherein, when a direction in which the tab lead extends from the end of the battery is defined as a first direction, the laser welding is performed such that welds are arranged in a plurality of linear rows extending in the first direction.

According to [4], since the rows of the plurality of welds are arranged in the direction of current, smoother current flow is possible.
[5] The laser processing method according to any one of [1] to [4], wherein a plurality of current collector foils are laminated.

According to [5], a plurality of current collector foils of a stacked battery can be efficiently welded together to a tab lead.

It is possible to provide a laser processing method capable of ensuring not only high welding strength but also low current density (low electrical resistance) by suppressing the gate effect near welds upstream of a current flow while suppressing the area of a weld region when welding current collector foils of a battery to a tab lead.

### BRIEF DESCRIPTION OF THE DRAWINGS

FIG. 1 is a plan view showing a portion of a lithium ion secondary battery in which a tab lead and a current collector foil are welded.

FIG. 2 is an enlarged view showing an example of a weld between the current collector foil and the tab lead in FIG. 1.

FIG. 3 is an enlarged view showing an example of a weld between the current collector foil and the tab lead in FIG. 1.

FIG. 4 is an enlarged view showing an example of a weld between the current collector foil and the tab lead in FIG. 1.

FIG. 5 is an enlarged view showing an example of a weld between the current collector foil and the tab lead in FIG. 1.

FIG. 6 is a contour diagram of the current density at a weld between a negative electrode current collector foil and a tab lead when a battery of Example 1 is being charged, and an arrow plot diagram showing a current flow in a part of the contour diagram.

FIG. 7 is a contour diagram of the current density at a weld between a negative electrode current collector foil and a tab lead when a battery of Example 2 is being charged, and an arrow plot diagram showing a current flow in a part of the contour diagram.

FIG. 8 is a contour diagram of the current density at a weld between a negative electrode current collector foil and a tab lead when a battery of Example 3 is being charged, and an arrow plot diagram showing a current flow in a part of the contour diagram.

FIG. 9 is a contour diagram of the current density at a weld between a negative electrode current collector foil and a tab lead when a battery of Example 4 is being charged, and an arrow plot diagram showing a current flow in a part of the contour diagram.

FIG. 10 is a contour diagram of the current density at a weld between a negative electrode current collector foil and a tab lead when a battery of Example 5 is being charged, and an arrow plot diagram showing a current flow in a part of the contour diagram.

FIG. 11 is a contour diagram of the current density at a weld between a negative electrode current collector foil and a tab lead when a battery of Example 6 is being charged, and an arrow plot diagram showing a current flow in a part of the contour diagram.

### DETAILED DESCRIPTION OF THE INVENTION

Hereinbelow, a laser processing method according to an embodiment of the present invention is described with reference to the drawings.

The method of the present embodiment includes a step of laser welding a current collector foil and a tab lead at an end of a battery by irradiating the same with laser light.

### (Battery)

Batteries to be processed by the laser processing method of the present embodiment are not particularly limited, and the laser processing method of the present embodiment can be applied to various known batteries. Examples of batteries include lead-acid batteries, lithium-ion secondary batteries, lithium-ion polymer secondary batteries, nickel-metal hydride batteries, nickel-cadmium batteries, nickel-iron batteries, nickel-zinc batteries, silver oxide-zinc batteries, and cobalt-titanium lithium secondary batteries. In particular, the laser processing method of the present embodiment can be suitably used for processing laminated batteries (laminated lithium-ion secondary batteries and the like).

The current collector foil may be either a positive or negative electrode current collector foil, but is preferably a negative electrode current collector foil. There is no particular restriction on the material of the current collector foil, but for the positive electrode current collector, for example, an aluminum foil, SUS, etc. can be used, and for the negative electrode current collector, a nickel foil, a copper foil, or an iron foil plated with nickel can be used. From the viewpoint of more reliably obtaining the effects of the present invention, the current collector foil is preferably a nickel foil or a copper foil as the negative electrode current collector, and more preferably a copper foil.

The current collector foil may also be laminated in a plurality of layers. That is, the processing method of the present embodiment can efficiently weld a plurality of current collector foils of a stacked battery together to a tab lead.

There is no particular restriction on the number of layers of the current collector foil, but it depends on required electrical characteristics. In addition, the number of layers of the current collector foil depends on the configuration of battery cells called an electrode group, but in the case of negative electrode-positive electrode-negative electrode, the number of layers of negative electrodes is twice that of positive electrodes. For example, when it is assumed that the battery is mounted in a car, the number of layers is preferably 15 to 100, more preferably 24 to 80, and even more preferably 27 to 54.

### (Tab Lead)

As a tab lead, a metal plate made of aluminum, an aluminum alloy, copper, a copper alloy, nickel, a nickel alloy, or the like can be used. From the viewpoint of more reliably obtaining the effects of the present invention, the tab lead is preferably a metal plate made of copper, a copper alloy, nickel, a nickel alloy, or the like as a negative electrode tab lead, and more preferably a metal plate made of copper or a copper alloy. From the viewpoint of bonding, the tab lead is preferably a metal plate made of the same material as the current collector foil. That is, for example, in the case of the negative electrode, when the current collector foil is a copper foil, it is desirable that the tab lead is also a copper plate.

### (Laser Welding)

Laser light used in laser welding is laser light selected from a blue laser and a green laser.

In this context, “laser light selected from a blue laser and a green laser” means laser light with a wavelength of 400 nm to about 580 nm.

The blue laser preferably has a wavelength of 480 nm to 400 nm, and more preferably has a wavelength of 400 nm to 465 nm.

The green laser preferably has a wavelength of 580 nm to 500 nm, and more preferably a wavelength of 560 nm to 500 nm.

In the present embodiment, laser light is preferably a blue laser.

When the wavelength of the laser light is within the above range, the laser light is highly absorbed by copper or nickel, and thus it is possible to lengthen a joining ridgeline (to be described below) while narrowing a bead width by using a focused laser source, particularly when the current collector foil and/or tab lead are made of copper or nickel.

In the present embodiment, laser light of different wavelengths within the above range may be multiplexed and radiated, or a blue laser and/or a green laser may be multiplexed with an infrared (IR) laser and radiated.

A known device can be used as a laser processing device (laser welding device) for laser welding, and for example, the devices described in Patent Document 1 and Patent Document 2 can be used.

Further, specific conditions for laser welding can be determined appropriately in consideration of the wavelength of laser light, the thickness and number of layers of the tab lead, an intended welding pattern, and the like.

### (Welding Pattern)

In the present embodiment, it is preferable to perform laser welding such that welds form a plurality of rows. More specifically, when the direction in which the tab lead extends from the battery end (the length direction of the tab lead) is defined as a first direction, it is preferable to perform the laser welding such that welds are arranged in a plurality of linear rows (weld beads) perpendicular to the first direction (hereinafter also referred to as “width direction welding”), or it is preferable to perform the laser welding such that the welds are arranged in a plurality of linear rows extending in the first direction (hereinafter also referred to as “length direction welding”). Among these, length direction welding is more preferred because a plurality of welds (weld beads) are arranged in a direction parallel to a current flow, allowing for smoother current flow. In the length direction welding, the rows of welds (weld beads) do not necessarily need to be completely parallel to the length direction of the tab lead, and it is preferable that they are inclined relative to the length direction from the viewpoint of improving the mechanical strength against the load in the direction in which the tab lead extends. In this context, the inclination angle is preferably, for example, 10° to 60°, and more preferably 20° to 45°.

By welding using radiation of the specific laser light, it becomes easy to increase the ridgeline length of the weld interface (interface with a melted-resolidified portion) in a limited area. In this context, the ridgeline of the weld interface is, in other words, the outline of a weld, and the outer periphery of a part that is raised to form a ridge.

In the present embodiment, since it is possible to increase the ridgeline length of the weld interface in a limited area, it is possible to ensure sufficient welding strength while reducing the current density at the weld.

In the case of thin beads, the ridgeline length is approximately twice the bead length, but since it is difficult to weld to the same width as the current collector foil, and since it depends on the size of the battery during formation of a plurality of beads, it is preferable that the ridgeline length is, for example, 80 mm to 120 mm, more preferably 190 mm to 290 mm, and even more preferably 120 mm to 190 mm. If the bead length becomes very long, it is good from the viewpoint of current density, but it should not be increased unnecessarily because it deteriorates the tact time and affects cells and a heat-welded resin. In addition, the ratio (L1/A1) of the ridgeline length (L1) to the welded area (A1) is preferably 3/100 to 28/100, more preferably 3/100 to 21/100, and even more preferably 13/100 to 5/100.

There are no particular limitations on the size, number, arrangement, and the like of weld portions in the present embodiment as long as the effects of the present invention can be achieved. For example, in the case of a laminated battery for vehicle mounting, in consideration of layout restrictions on the weld region, the laser spot diameter is preferably 0.08 mm to 0.6 mm, more preferably 0.08 mm to 0.25 mm, and even more preferably 0.08 mm to 0.15 mm.

Further, the weld portions may be in a continuously linear shape, or a plurality of weld points may be scattered at a predetermined pitch. When a plurality of weld points are scattered at a predetermined pitch, the pitch (the distance between the centers of adjacent weld points) depends on the diameter and width of the weld points, but for example, the pitch (P1) of melting points needs to be larger than the diameter (D1) of the weld points, and the ratio of P1/D1 is preferably 2.5 to 15, more preferably 2.5 to 10, and even more preferably 2.5 to 6. When the ratio of P1/D1 is equal to or greater than the lower limit, the conductive performance at the welds can be sufficiently ensured. When the ratio of P1/D1 is equal to or less than the lower limit, it becomes easier to ensure sufficient welding strength.

As a specific example, when the diameter (D1) of the weld point is 0.4 mm, it is preferable that the pitch (P1) of the melting points is 1.0 mm or greater. When P1 is 1.0 mm, the distance between non-weld portions of adjacent melting points is 0.6 mm.

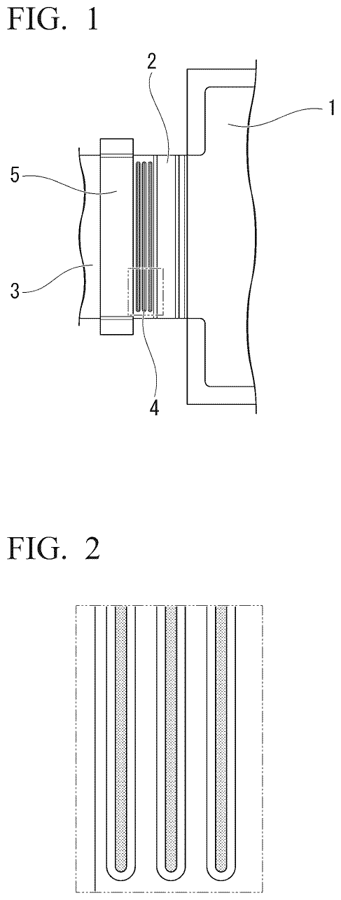

Specific welding patterns are described below with reference to FIG. 1 to FIG. 5.

FIG. 1 is a plan view showing a lithium ion secondary battery in which a current collector foil is welded to a tab lead. At an end of a laminated lithium ion secondary battery 1, a current collector foil 2 protrudes. The current collector foil 2 and the tab lead 3 are welded at a weld region 4.

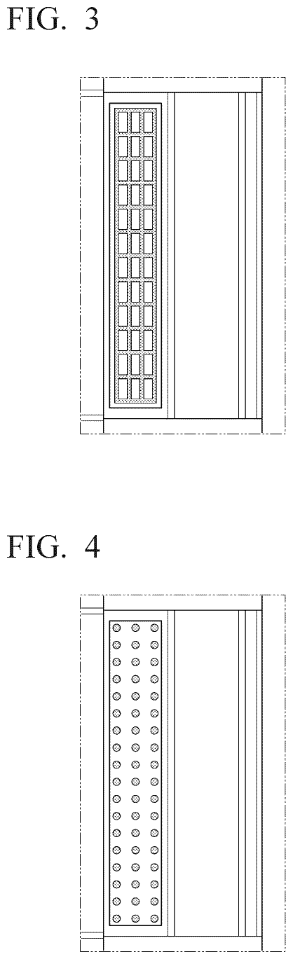

FIG. 2 and FIG. 3 show enlarged views of welds. The welding pattern shown in FIG. 2 is an example of the width direction welding described above, in which, when the direction in which the tab lead 3 extends from the end of the battery 1 (i.e., the length direction of the tab lead 3) is defined as a first direction, a plurality of rows of linear weld beads extend in a direction (i.e., the width direction of the tab lead 3) perpendicular to the first direction. In the case of this welding pattern, if the length (number) of the rows of welds (weld beads) excessively increases, the joint resistance at the welds increases, and there are cases in which the current density cannot be sufficiently reduced for the electrode (electrical resistance increases).

In FIG. 3, weld beads are formed in a lattice form. In this instance, a longer ridgeline is secured compared to the welding pattern in FIG. 2, and thus a higher welding strength is achieved. However, the current flow is more significantly hindered than in the welding pattern in FIG. 2, and as a result, the current density increases upstream of the current flow, and there is a tendency that a low current density for the electrode cannot be secured (electrical resistance increases). The reason for this is that large blowholes remain inside the melted-resolidified portion that is a flow path through which current passes, many fine bubbles emerge near the outer edge of the ridgeline thereof, and this phenomenon cannot be removed. Particularly, in the cause of aluminum, cracks called necking occur near the ridgeline, and it is difficult to suppress the cracks and eliminate the same through secondary melting; therefore, practical facts need to be taken into consideration in order to satisfy the welding strength and electrical characteristics.

Instead of continuous linear weld beads, it is also within the scope of the present invention to employ a pattern in which a plurality of weld points provided at a predetermined pitch are arranged in a plurality of rows of parallel straight lines as shown in FIG. 2, or a pattern in which a plurality of weld points provided at a certain pitch are arranged in a lattice form as shown in FIG. 3. In either case, it is possible to not only increase the ridgeline length of the weld interface to ensure welding strength, but also allow current to flow between weld points to reduce the current density in the vicinity of the weld portions by using a plurality of weld points.

FIG. 4 is an enlarged view showing an example of tab lead welds according to the laser processing method of the present embodiment. In FIG. 4, the plurality of weld points are arranged at a predetermined pitch in a plurality of linear rows A extending in the width direction of the tab lead 3, and the centers of weld points of adjacent rows A are arranged to be located on the same straight line extending in the length direction of the tab lead 3. Even with such an arrangement, the ridgeline length of the weld interface can be increased by the plurality of weld points and welding strength can be ensured, but from the viewpoint of reducing the current density, it is preferable to arrange the weld points such that the centers of weld points of adjacent rows A are not located on the same straight line extending in the length direction of the tab lead 3.

The number of rows A is not particularly limited, but from the viewpoint of ensuring a balance between welding strength and current density, 2 to 5 rows are preferable, and from the viewpoint of layout, 3 rows are particularly preferable.

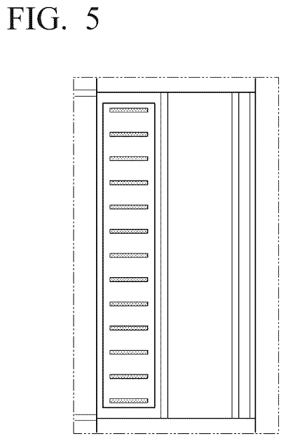

FIG. 5 is an enlarged view showing another example of tab lead welds according to the laser processing method of the present embodiment. The welding pattern shown in FIG. 5 is an example of the length direction welding described above.

In FIG. 5, the welds are arranged in a plurality of linear rows B extending in the first direction (i.e., the length direction of the tab lead 3). In this instance, the plurality of welds (weld beads) are arranged parallel to the direction of current, allowing for smoother current flow.

The number of rows B is not particularly limited, but from the viewpoint of ensuring a balance between welding strength and current density, 6 to 20 rows are preferable, and 10 to 16 rows are more preferable. However, since the weld length should also be suppressed, it is important from the perspective of layout that the length does not exceed approximately 3 mm, which naturally results in a larger number of rows.

### Operation and Effects

According to the present invention, by using a welding method using a spatter-reduced laser source and applying a plurality of beads in an area where a layout pattern is limited by a small-diameter spot, it is possible to secure a long ridgeline of a molten part which is several times longer than that in the case of a melting area equivalent to an ultrasonic welding area, etc., so that even if there is some joint failure, electrical performance can be sufficiently guaranteed, thereby solving the above-described problems of joint resistance and strength.

In other words, many weld ridgelines are available, and a weld area can thereby be narrowed, which allows for layout reduction and allows the weld area to serve as a heat dissipation area.

In addition, spatter and metal powder scattering are suppressed by spatterless laser welding, and it is possible to eliminate the root cause of contamination generation, and it is also possible to obtain the effect of being free from high maintenance management required for resistance welding and ultrasonic welding.

The technical scope of the present invention is not limited to the above-mentioned embodiment, and various modifications can be made within the scope of the present invention. In addition, it is possible to appropriately replace the components in the above-mentioned embodiment with well-known components within the scope of the present invention.

### EXAMPLES

The present invention is described in more detail below with reference to examples, but the present invention is not limited to the following examples.

### Experimental Example 1

### [Preparation of Lithium Ion Secondary Battery]

A lithium-nickel-cobalt-manganese composite oxide as a lithium composite oxide, acetylene black as a conductive additive, and styrene butadiene rubber (SBR) as a binder were mixed to obtain a coating solution for a positive electrode mix layer.

As a positive electrode current collector, an Al foil with an area of 100 cm² and a thickness of 12 μm was used. The coating solution for the positive electrode mix layer was applied to the Al foil, and then dried to form a positive electrode mix layer of 20 mg/cm², which was then rolled to obtain a positive electrode.

As a negative electrode current collector and separator, a Cu foil with an area of 12 cm² and a thickness of 6 μm and a porous polyethylene (PE) film with a thickness of 20 μm were used, respectively.

27 sheets of the positive electrodes (each composed of the positive electrode mix layer and the positive electrode current collector) and 54 sheets of the negative electrode current collector were stacked with the separator interposed therebetween. A positive electrode tab lead (0.8 mm thick) made of Al was welded to the aluminum foil which is the positive electrode current collector.

Further, a negative electrode tab lead (0.6 mm thick) was laser welded to the copper foil which is the negative electrode current collector under the following conditions.
Laser light: Blue laser (wavelength 450 nm)
Melting-resolidification width: 0.2 to 0.4 mm
Laser power: 1 to 3 kW
Weld spot diameter: 0.2 to 0.8 mm
Scanning speed: 4 to 40 mm/sec
Scanning trajectory: Linear pattern: AL:pulse radiation, Cu:CW and linear (fixed point) movement by wobbling. Both SPOT patterns were fixed point rotation.
Ar gas flow rate: 20 L/min
Thermal conductivity λ of fixture: 80 w/m·k
Applied waveform: continuous wave (CW)

Sample cells 1 to 8 were created with different welding patterns for the negative electrode tab lead. The welding patterns for sample cells 1 to 8 are as follows.
Sample cell 1: A welding pattern in which one row of linear weld beads extending in the width direction of the tab lead 3 as shown in FIG. 2 is arranged (pattern name: “Single cross-current flow straight line”).
Sample cell 2: A welding pattern in which two rows of linear weld beads extending in the width direction of the tab lead 3 as shown in FIG. 2 are arranged (pattern name: “Two cross-current flow straight lines”).
Sample cell 3: A welding pattern in which three rows of linear weld beads extending in the width direction of the tab lead 3 as shown in FIG. 2 are arranged (pattern name: “Three cross-current flow straight lines”).
Sample cell 4: A welding pattern in which four rows of linear weld beads extending in the width direction of the tab lead 3 as shown in FIG. 2 are arranged (pattern name: “Four cross-current flow straight lines”).
Sample cell 5: A welding pattern in which three linear rows of weld points extending in the width direction of the tab lead 3 as shown in FIG. 4 are arranged (pattern name: “3-row spot”).
Sample cell 6: A welding pattern in which four linear rows of weld points extending in the width direction of the tab lead 3 as shown in FIG. 4 are arranged (pattern name: “4-row spot”).
Sample cell 7: A welding pattern in which five linear rows of weld points extending in the width direction of the tab lead 3 as shown in FIG. 4 are arranged, and the weld points are arranged such that the centers of weld points in adjacent rows are not located on the same straight line extending in the length direction of the tab lead 3 (pattern name: “5-row staggered”).
Sample cell 8: A welding pattern in which five rows of weld spot lines (rows of weld points arranged on straight lines) extending in the length direction of the tab lead 3 as shown in FIG. 5 are arranged (pattern name: “Current flow parallel line”).

The dimensions and other characteristics of sample cells 1 to 8 are shown in Table 1.

### [Evaluation of Resistance Tendency]

The resistance tendency of the obtained sample cells 1 to 8 was evaluated based on the ridgeline length according to the following criteria. (The longer the ridgeline, the lower the resistance.)
A: Ridgeline length is 400 mm or more
B: Ridgeline length is 150 mm or more and less than 400 mm
C: Ridgeline length is less than 150 mm

The results are shown in Table 1.

TABLE 1

| Sample cell | 1 | 2 | 3 | 4 | 5 | 6 | 7 | 8 |
|---|---|---|---|---|---|---|---|---|
| Welding | Single | Two | Three | Four | 3-row | 4-row | 5-row | Current |
| pattern | cross- | cross- | cross- | cross- | spot | spot | staggered | flow |
| | current | current | current | current | | | | parallel |
| | flow | flow | flow | flow | | | | line |
| | straight | straight | straight | straight | | | | |
| | line | lines | lines | lines | | | | |
| Length of | 45 | 45 | 45 | 45 | 0 | 0 | 0 | 3.6 |
| one weld | | | | | | | | |
| bead | | | | | | | | |
| (mm) | | | | | | | | |
| Total | 90 | 180 | 270 | 360 | 0 | 0 | 0 | 381.6 |
| length of | | | | | | | | |
| weld | | | | | | | | |
| ridgelines | | | | | | | | |
| (mm) | | | | | | | | |
| Total | 91 | 183 | 274 | 365 | 196.092 | 261.456 | 326.82 | 448.221 |
| length of | | | | | (90 spots) | (118 spots) | (149 spots) | |
| ridgelines | | | | | | | | |
| (mm) | | | | | | | | |
| Resistance | C | B | B | B | B | B | B | A |
| tendency | | | | | | | | |

### Experimental Example 2

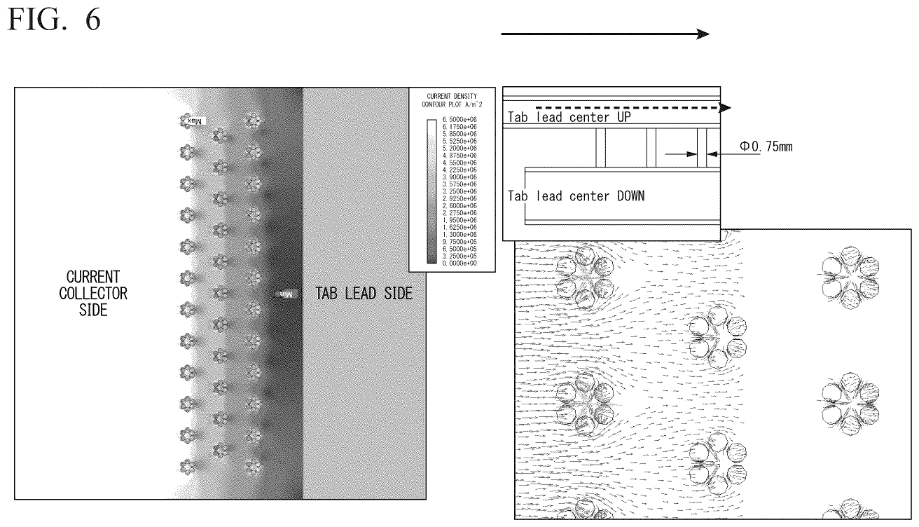

A lithium ion secondary battery was created in the same manner as in Experimental Example 1, except that the welding pattern of the negative electrode tab lead was as shown in FIG. 6. In FIG. 6, five dots (circles) are aggregated to form a petal shape, and this collection of five dots is a schematic blowhole, and the area surrounded by such blowholes is a melted-resolidified portion. In this analysis result, the diameter of the blowhole was 0.75 mm, which is 10 times the size. Further, the pitch of the blowholes was 3.8 mm.

The current density distribution was analyzed under the following conditions for the negative electrode tab lead welds of the obtained lithium ion secondary battery.

Analysis application: J-MAG Designer

Analysis conditions: Appropriately set according to the model dimensions. The current was 108 A.

The results are shown in FIG. 6.

The thickness of the negative electrode tab lead is 0.6 mm, whereas the thickness of the Cu foil is 0.8 mm, which is larger, and thus the current density on the side of the Cu foil is lower than that on the side of the negative electrode tab lead.

Although the diameter of the blowhole was relatively large, it was confirmed that current flowed up to the third row as seen from the negative electrode tab lead.

### Experimental Example 3

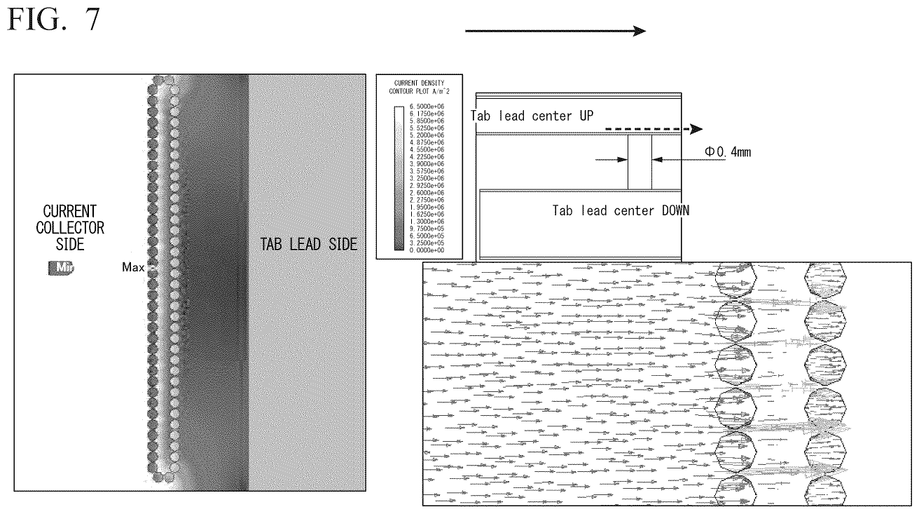

A lithium ion secondary battery was created in the same manner as in Experimental Example 1, except that the welding pattern of the negative electrode tab lead was as shown in FIG. 7. The plurality of dots (circles) shown in FIG. 7 are blowholes, and the area surrounded by these blowholes is a melted-resolidified portion. In FIG. 7, there is one row of weld portions (weld beads).

The current density distribution was analyzed in the same manner as in Experimental Example 2 for the negative electrode tab lead welds of the obtained lithium ion secondary battery.

The results are shown in FIG. 7.

Because the weld resolidification width was set to a wide 0.7 mm, there was a current flow relatively in one row, but there were areas with high current density in places other than the flow at both ends, and it can be ascertained that a smooth current flow was not formed. The ideal melting-resolidification width is about 0.3 mm, and in such a case, a more remarkable effect is shown.

### Experimental Example 4

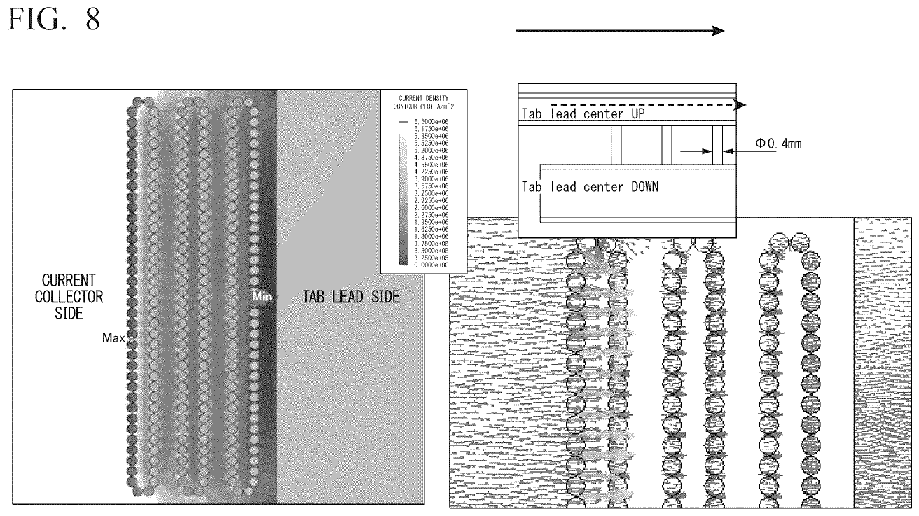

A lithium-ion secondary battery was created in the same manner as in Experimental Example 1, except that the welding pattern of the negative electrode tab lead was as shown in FIG. 8. The plurality of dots (circles) shown in FIG. 8 are blowholes, and the area surrounded by these blowholes is a melted-resolidified portion. In FIG. 8, there are three rows of weld portions (weld beads).

The current density distribution was analyzed in the same manner as in Experimental Example 2 for the negative electrode tab lead welds of the obtained lithium-ion secondary battery.

The results are shown in FIG. 8.

Since the weld resolidification width is 0.7 mm, which is wider than the total thickness t of the current collector foils (the sum of the thicknesses of all the current collector foils), there is a relatively abundant current flow in the first row as seen from the negative electrode tab lead, but there are areas with high current density in places other than the flow at both ends. Current flow was also confirmed in the second and third rows.

### Experimental Example 5

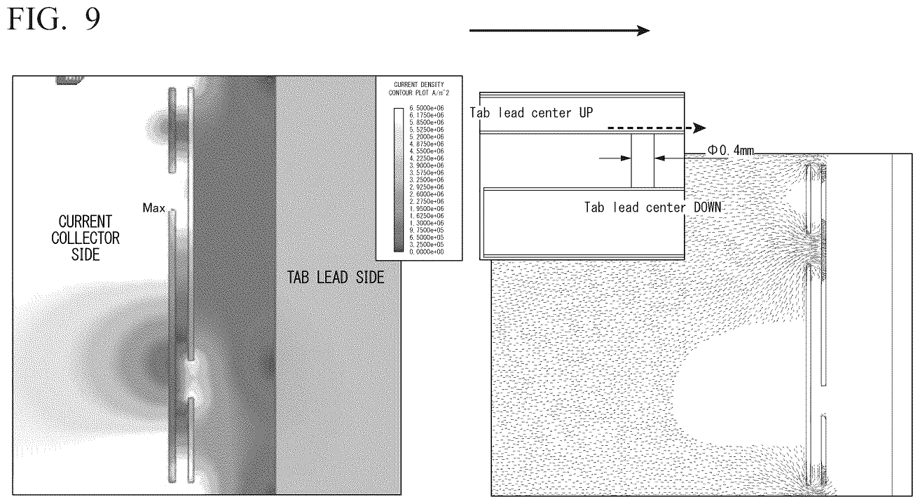

A lithium ion secondary battery was created in the same manner as in Experimental Example 1, except that the welding pattern of the negative electrode tab lead was as shown in FIG. 9.

The current density distribution was measured in the same manner as in Experimental Example 2 for the negative electrode tab lead welds of the obtained lithium ion secondary battery.

The results are shown in FIG. 9.

A large bias in the current density distribution was confirmed, and it can be ascertained that at both ends of the linear weld portion (weld bead), the current leaks out to the opposite side of the current flow.

### Experimental Example 6

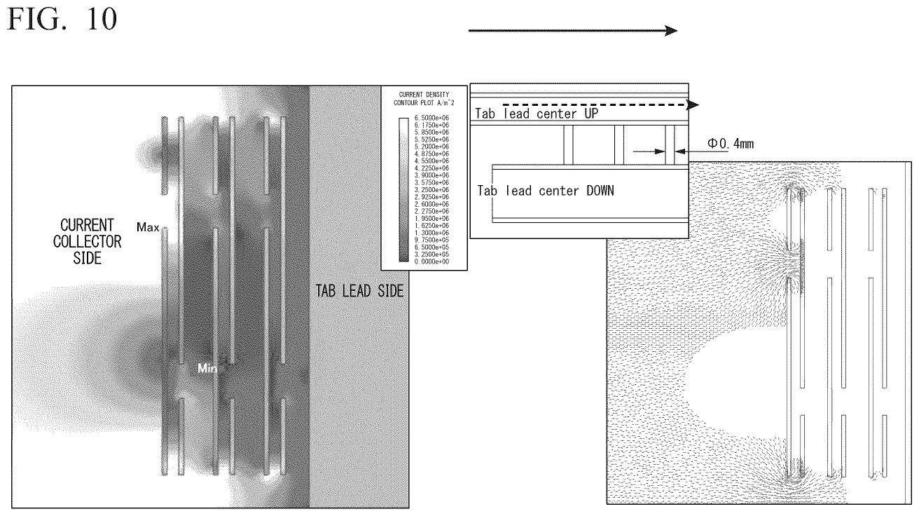

A lithium ion secondary battery was created in the same manner as in Experimental Example 1, except that the welding pattern of the negative electrode tab lead was as shown in FIG. 10.

The current density distribution was analyzed in the same manner as in Experimental Example 2 for the negative electrode tab lead welds of the obtained lithium ion secondary battery.

The results are shown in FIG. 10.

A large bias in the current density was confirmed as in Experimental Example 5, and the leaked current at both ends of the linear weld portion (weld bead) flows to the side of the tab lead in the second and third rows as seen from the tab lead.

### Experimental Example 7

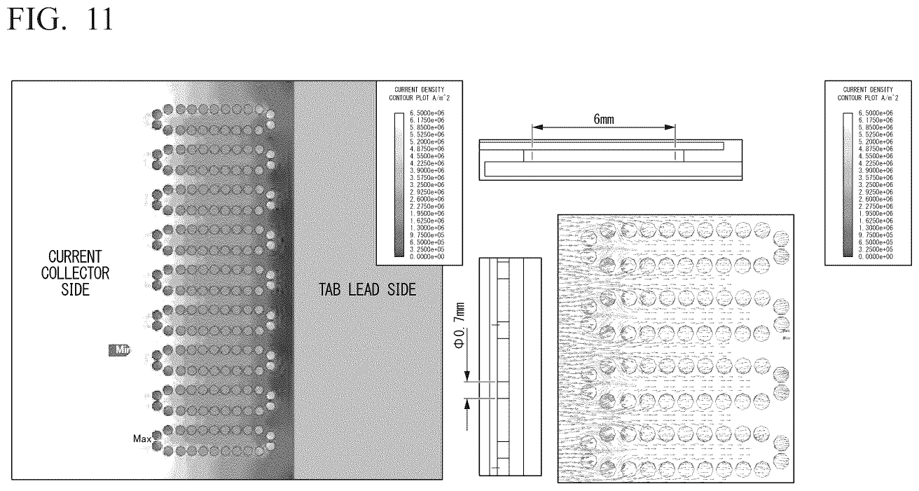

A lithium ion secondary battery was created in the same manner as in Experimental Example 1, except that the welding pattern of the negative electrode tab lead was as shown in FIG. 11.

The current density distribution was analyzed in the same manner as in Experimental Example 2 for the negative electrode tab lead welds of the obtained lithium-ion secondary battery.

The results are shown in FIG. 11.

Current gradually flows into weld portions from the periphery in the direction of current flow, a contour gradation can be seen at both ends of the weld portions, and vectors are also smooth.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Laminated lithium ion secondary battery
2 Current collector foil
3 Tab lead
4 Weld region
5 Sealing material

What is claimed is:

1. A laser processing method comprising a step of laser welding a current collector foil and a tab lead at an end of a battery,
wherein the step of laser welding is performed by radiating laser light selected from a blue laser and a green laser.

2. The laser processing method according to claim 1, wherein, when a direction in which the tab lead extends from the end of the battery is defined as a first direction, the laser welding is performed such that welds are arranged in a plurality of linear rows perpendicular to the first direction.

3. The laser processing method according to claim 2, wherein the number of rows of the welds is two or more.

4. The laser processing method according to claim 1, wherein, when a direction in which the tab lead extends from the end of the battery is defined as a first direction, the laser welding is performed such that welds are arranged in a plurality of linear rows extending in the first direction.

5. The laser processing method according to claim 1, wherein a plurality of current collector foils are laminated.
